(19) United States
(12) Patent Application Publication
(10) Pub. No.: US 2013/0159527 A1
(43) Pub. Date: Jun. 20, 2013

(54) SYSTEM AND METHOD FOR ELECTRONIC SOCIAL NETWORKING

(71) Applicant: Sean Roach, Carson City, NV (US)

(72) Inventor: Sean Roach, Carson City, NV (US)

(21) Appl. No.: 13/766,708

(22) Filed: Feb. 13, 2013

Related U.S. Application Data
(63) Continuation of application No. 12/114,524, filed on May 2, 2008.
(60) Provisional application No. 60/927,538, filed on May 3, 2007.

(51) Int. Cl. H04L 12/24

(52) U.S. Cl. CPC H04L 41/00
USPC 709/225

(57) ABSTRACT

According to one embodiment, a system for controlling access to data on an electronic communication network is provided. The system includes at least one server connectable for communication on the network. The at least one server is configured for: receiving data from at least one user of a plurality of users, via the network; storing the received data; generating control levels corresponding to one or more portions of the stored data; receiving selected modifications to at least one of the generated control levels from the at least one user, via the network; providing controlled access to the one or more portions of the stored data according to the generated control levels and the modified at least one of the generated control levels.

### CROSS-REFERENCE TO RELATED PATENT APPLICATIONS

This application claims priority to and the benefit of U.S. Provisional Patent Application No. 60/927,538, filed May 3, 2007, the content of which is incorporated herein by reference in its entirety.

### FIELD OF THE INVENTION

Embodiments of the present invention relate to network communication systems that may be used, for example, in a social network context, with access controls that allow selection of one of multiple levels of access. In particular embodiments, a graphical user interface is provided with a slider control for selecting access levels.

### BACKGROUND OF THE INVENTION

Systems for controlling access to content on a communications network have involved discrete, pre-defined access levels that are typically set by a system administrator for all users on a system. Role-based access systems may be appropriate for certain contexts in which there are a limited number of pre-known types of users that can be assigned pre-set access levels based on the known role of that user. Thus, a company may organize a role-based access system such that all users within the company who perform a management role may have a pre-assigned high level of access, whereas all users that perform a clerical role may have a pre-assigned low level of access. Examples of such systems include those described in U.S. Pat. Nos. 6,947,989; 6,985,955; 6,871,232; 6,023,765; 6,453,353; 6,910,041; and 6,976,270, each of which is incorporated herein by reference.

However, such role-based systems may not be practical in a social network context, where there may be many different access levels that change or differ among different users accessing different network locations. Furthermore, typical role-based systems do not allow each user an ability to define and select access levels for other users.

### SUMMARY OF THE INVENTION

According to one embodiment, a system for controlling access to data on an electronic communication network is disclosed. The system includes at least one server connectable for communication on the network. The at least one server is configured for: receiving data from at least one user of a plurality of users, via the network; storing the received data; generating control levels corresponding to one or more portions of the stored data; receiving selected modifications to at least one of the generated control levels from the at least one user, via the network; providing controlled access to the one or more portions of the stored data according to the generated control levels and the modified at least one of the generated control levels.

According to another embodiment, a method for controlling access to data on an electronic communication network is disclosed. The method includes: connecting at least one server for communication on the network; and configuring the at least one server for: receiving data from at least one user of a plurality of users, via the network; storing the received data; generating control levels corresponding to one or more portions of the stored data; receiving selected modifications to at least one of the generated control levels from the at least one user, via the network; and providing controlled access to the one or more portions of the stored data according to the generated control levels and the modified at least one of the generated control levels.

According to another embodiment, a system for managing data on an electronic communication network is disclosed. The system includes at least one server connectable for communication on the network. The at least one server is configured for: receiving data from a first user of a plurality of users, via the network; receiving data from a second user of the users, via the network; storing the first user data and the second user data; receiving descriptors corresponding to one or more portions of the stored first user data from the first user, via the network; receiving descriptors corresponding to one or more portions of the stored second user data from the second user, via the network; locating at least one match between the first user descriptors and the second user descriptors; and upon the location of the at least one match, providing a recommendation, via the network of one of the first user and the second user to the other of the first user and the second user.

According to another embodiment, a method for managing data on an electronic communication network is disclosed. The method includes: connecting at least one server for communication on the network; and configuring the at least one server for: receiving data from a first user of a plurality of users, via the network; receiving data from a second user of the users, via the network; storing the first user data and the second user data; receiving descriptors corresponding to one or more portions of the stored first user data from the first user, via the network; receiving descriptors corresponding to one or more portions of the stored second user data from the second user, via the network; locating at least one match between the first user descriptors and the second user descriptors; and upon the location of the at least one match, providing a recommendation, via the network of one of the first user and the second user to the other of the first user and the second user.

According to another embodiment, a system for managing communications between a plurality of users on an electronic communication network is disclosed. The system includes at least one server connectable for communication on the network. The at least one server is configured for: receiving a plurality of access levels from the users, each of the access levels granted from one of a corresponding pair of the users to the other of the corresponding pair; storing the access levels; receiving, from a requesting user of the users, a request for an introduction to a target user of the users; locating an intermediate user based on the access levels granted from the target user to the intermediary user and from the intermediary user to the requesting user; and arranging the introduction of the requesting user to the target user via the intermediate user.

According to another embodiment, a method for managing communications between a plurality of users on an electronic communication network is disclosed. The method includes: connecting at least one server for communication on the network; and configuring the at least one server for: receiving a plurality of access levels from the users, each of the access levels granted from one of a corresponding pair of the users to the other of the corresponding pair; storing the access levels; receiving, from a requesting user of the users, a request for an introduction to a target user of the users; locating an intermediate user based on the access levels granted from the target user to the intermediary user and from the intermediary user to the requesting user; and arranging the introduction of the requesting user to the target user via the intermediate user.

These and other aspects will become apparent from the following drawings and detailed description of exemplary embodiments.

### BRIEF DESCRIPTION OF THE DRAWINGS

FIG. 1 is a generalized schematic diagram of a system environment according to an embodiment of the present invention.

FIG. 2 is a generalized flow chart showing an example user-access process.

FIG. 3 is a generalized flow chart showing examples of optional processes for non-registered users.

FIG. 3A is a generalized flow chart showing examples of optional processes for registered users.

FIG. 4 shows a screen template provided to a registered user according to one embodiment.

FIG. 5 shows a screen template provided to a registered user according to one embodiment.

FIG. 6A is a generalized flow chart showing processes for determining whether to grant or deny a user access to information, according to one embodiment.

FIG. 6B is a generalized flow chart showing processes for determining whether to grant or deny a user access to information, according to one embodiment.

FIG. 7 is a preview screen provided to a registered user according to one embodiment.

FIG. 8 is a preview screen provided to a registered user according to one embodiment.

FIG. 9 is a preview screen provided to a registered group owner according to one embodiment.

FIG. 10 is a generalized flow chart showing processes for providing recommendations between users, according to one embodiment.

FIG. 11A shows an generalized flow diagram showing an introduction of an requesting user to a target user, according to one embodiment.

FIG. 11B shows an generalized flow diagram showing an introduction of an requesting user to a target user, according to one embodiment.

### DETAILED DESCRIPTION OF THE PREFERRED EMBODIMENTS

The following detailed description is of the best presently contemplated mode of implementing embodiments of the invention. This description is not to be taken in a limiting sense, but is made merely for the purpose of illustrating general principles of embodiments of the invention. The scope of the invention is best defined by the appended claims.

Embodiments of the present invention employ software components that operate with network devices and related hardware to manage the movement of electronic information, store the information in an organized format and provide controlled, worldwide access over the Internet to the information. The information may relate to text and other media (e.g., audio, visual, and/or audiovisual files) that are provided in an electronic social network context, and the system and services may involve users of an electronic social network.

For example, embodiments of the invention relate to systems and processes for managing data regarding personal and professional interests of a plurality of users over a wide area network, such as the Internet. Embodiments of the system are particularly suited for collecting and managing data relating to one or more individual users (and/or one or more groups of such users), where the managed data may be used to provide controlled access to the data, via the network, to other users via the network.

Hardware System Environment:

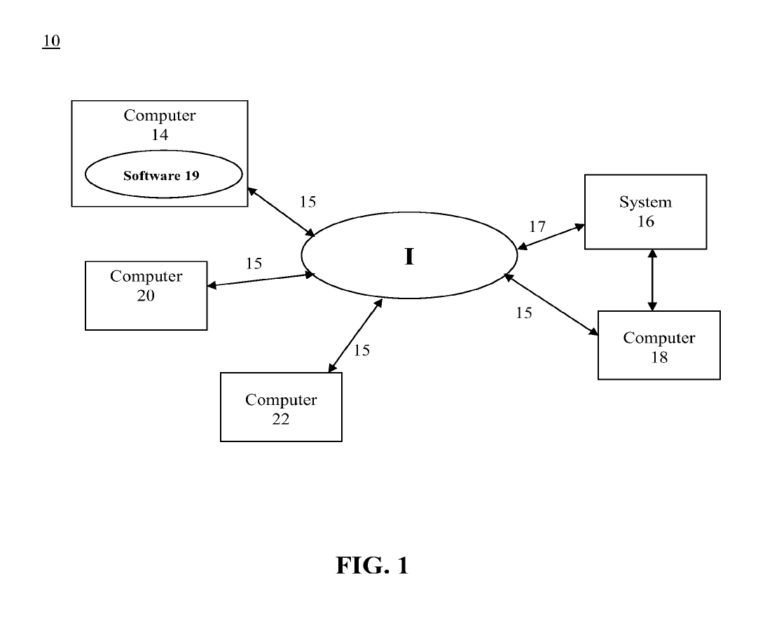

A generalized diagram of a system 10 according to embodiments of the present invention is shown in FIG. 1. Example embodiments of the system 10 are described herein with reference to use in social network contexts. In such embodiments, users (preferably multiple) are each provided with at least one (or multiple) computer 14. Each computer 14 may be connectable to a wide area network, such as the Internet. The system 10 also includes a data management system 16 connected to the wide area network and which is described in more detail below.

Depending upon the environment of use, embodiments may also include additional network devices, such as additional computers, connected in the system 10 through the wide area network. For example, as part of the data management system 16 (or as a separate element), one or more system personnel, such as customer service operators and/or system administrators may be connected for communication in system 10, via a computer or other suitable network device 18. Such system personnel may be trusted individuals, employed by (or otherwise associated with) an entity administering the system 16, such that appropriate security and controls may be implemented for system personnel handling or having access to subject information. In some embodiments described below, system personnel may include system administrators or other information technology personnel that may have access to some or all subject information stored on the system 16, to provide assistance to users.

The user provided with the computer 14 may or may not be registered on the system. Alternatively or in addition, one or more users may be connected to the network for communication in the system 10, each via a respective computer. In the context of a social network system, one of the users may be a registered user connected to the network for communication in the system via computer 20. Another user may be an unregistered user connected to the network for communication in the system via computer 22.

The computers or other network devices 14, 18, 20 and 22 may each include a conventional personal computer (e.g., a desktop or a laptop computer) or other suitable network-connectable communication device having data processing capabilities. For some embodiments with similar functions, the network device may include, but is not limited to, a personal digital assistant (PDA), a mobile telephone, a multimedia mobile telephone (e.g., an iPhone), a convergent wireless device (e.g., a BlackBerry), a pager, or the like. Depending upon the embodiment and environment of use, the computers or other network devices 14, 18, 20 and 22 may include or otherwise be associated with a user input device (such as, but not limited to, a keyboard, keypad, mouse, touch screen, optical input device, or the like) and a display device (such as, but not limited to, a cathode-ray tube monitor, an LCD display, an LED display, a plasma display or the like). For convenience and simplification of this disclosure (and without limiting the present invention), embodiments are described herein with reference to the network devices 14, 18, 20 and 22 as computers.

As described above, each computer 14 is coupled for communication over a wide area network, such as the Internet, through a respective communication link 15. The communication link 15 may include any suitable communications connection and may employ, for example, a suitable Internet Service Provider (ISP) connection to the Internet and/or include a hard wired connection, a wireless connection, an optical connection, a combination of the foregoing, or the like. While not shown in the drawing, suitable modem, cable-modem, satellite, DSL or other system elements may be employed for connecting the computer 14 to the Internet. Similar communication links may be employed for connecting computers 18, 20 and 22 for communication over the Internet.

The data management system 16 is coupled for communication over the wide area network, such as the Internet, through one or more further communication links 17. The link(s) 17 may include any suitable communications connection and, for example, may employ one or more suitable Internet Service Provider (ISP) connection to the Internet and/or a hard wired connection, a wireless connection, an optical connection, a combination of the foregoing, or the like. While not shown in the drawing, suitable modem, cable-modem, satellite, DSL or other system elements for connecting the data management system 16 to the wide area network may be employed.

The data management system 16 includes software that runs on at least one (or multiple) server(s) connected to the Internet. The system 10 may also include additional system software 19 residing on the computer 14 for interacting with the data management system 16 and providing functions described herein. The software 19 may be stored in a hard disk drive or other suitable computer-readable storage device connected to the user computer 14. The software 19 may be supplied to the respective users by any suitable means, including, but not limited to, computer-readable discs delivered to the user by mail or other form of delivery, or by uploading such software to the user computer 14 from the system 16, through an Internet connection, for example, during a registration procedure (as described in more detail below). Other system software (not shown) may be provided on the operator or administrator computer(s) 18, for providing similar functions and/or other functions for which the operator or administrator may be authorized to perform. The software for system 16 and the software residing on computer 14 may be configured using any suitable standard or non-standard software coding techniques to provide functions described herein. Alternatively, or in addition, the functions of the management system 16 and/or the user computer 14 described herein may be implemented in suitably configured hardware circuitry or combinations of hardware and software.

In general, the data management system 16 may be configured to provide any one or combination of functions to provide an expanded capability to facilitate individual users, as well as groups of such users having, for example, similar personal and/or professional interests or other characteristics.

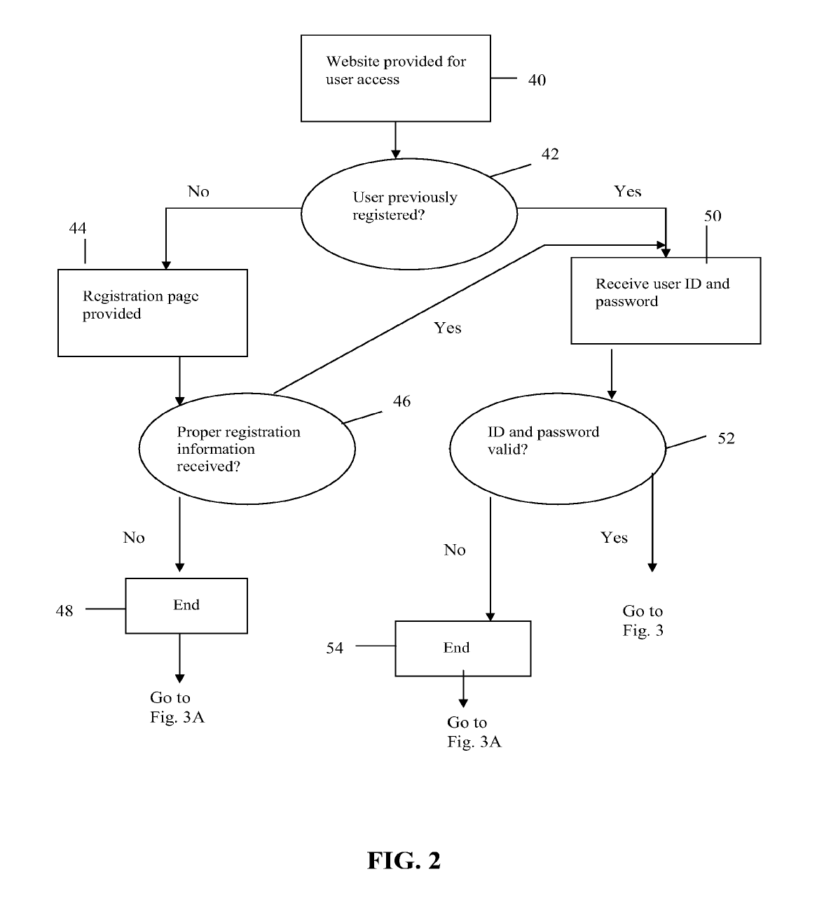

FIG. 2 shows a flow chart of an example process of providing a member-user (a registered user) with access to information and services available from the data management system 16 through a system 16 website. In box 40 of FIG. 2, the data management system 16 provides an Internet website for access by a member-user. The website may be provided on one or more host servers using conventional (or suitable non-conventional) website hosting techniques and suitable security measures to provide secure, controlled access to website locations, links and data. The website may include a plurality of website pages (or locations), accessible from selectable icons (or links) from other pages (or locations) on the site, in accordance with well known principles of website design and operation.

A user may access the website by launching a commonly available Internet Web Browser program on a personal computer. The user may connect to the Web through a common Internet Service Provider (for example, but not limited to, SBC/Yahoo, America Online, etc.). The user enters the address for a system 16 web site into the Web Browser program and accesses the website opening page to begin a communication session with the system 16.

The opening page (or another location on the website) may include a message or other indicia to prompt the user to enter information indicating whether or not the user has previously registered in the system 16. The system 16 is configured to receive such information from the user and, based on that information, to make an initial determination of whether or not the user has previously registered, as represented by box 42. If not, the user may be provided with a registration page, in which the user is prompted to enter registration information, as represented by box 44.

As part of the registration process, or as part of other communication processes with the system 16, the user may be prompted by the system 16, or otherwise provided access (for example, by link, pop-up window, directed page or other location on the system 16 website), to review terms or conditions of acceptance, including, but not limited to, privacy terms and conditions. The system 16 also may require the user to acknowledge acceptance of terms or conditions, for example, by selecting an acceptance icon or entering other information in the user's computer or subject support device, for communication to the system 16 over the network connection. Similarly, the system 16 may require the user to verify age, place of residence, citizenship or other information that may be useful or legally required in certain countries or geographical regions.

From the registration page, a user may be prompted to enter user-specific information. Registration information regarding a user may include contact information (such as user identification, postal address, telephone number(s), email address and the like). Registration information also may include security information for forming security questions used by the system 16 during subsequent user interactions with the system 16.

The system 16 is configured to receive registration information entered by the user from the registration page (or other suitable location on the website) and to determine if the information is valid or otherwise proper, as represented by box 46 in FIG. 2. If the system 16 determines that it did not receive proper registration information, the system 16 may provide the user with a message or other indicia indicating the failure to receive registration information and may either return the user to the registration page (box 44) or end the session (box 48). If the system 16 determines that registration information received from a user appears proper, the system 16 allows the user to proceed with the session, as represented by the “Y” arm extending from box 46.

As part of the registration process, the system 16 may upload software routines or programs, data or combinations thereof to the computer 14, for controlling the computer to provide functions described herein. Also as part of the initial registration process, a new user-registrant may be required to exit the system website and re-access the system (to re-enter the user name and password) before being allowed to conduct further activities with the system. For additional security, the user may be required to select a new password upon the user's first re-access of the system 16 website after the user's initial registration.

If the user has previously registered, the data management system may provide the user with a message or other indicia to prompt the user to enter the user's previously registered identification information, such as a unique user name or identification code, and a password, as represented by box 50. The system 16 may include suitable security features for allowing the user to communicate the password in a secure manner. Such security features may include suitable encryption techniques, or the like. Depending upon the type of security employed, the system 16 and the user's computer may communicate encryption keys or other security information, for example, during a handshake procedure (or other suitable time in the session).

The system 16 is configured to receive the user identification information and password and to verify the information and password, to determine if the user information and password appear valid, as represented by box 52 in FIG. 2. Verification of the information and password may be carried out by the system 16, in any suitable manner, including, but not limited to, comparing the received password with a pre-stored password corresponding to the user identification information received from the user. Thus, for example, the system 16 may include or employ a secure storage of a table (or other format) of user identification information with corresponding passwords, to allow the system to perform a table look-up (or other suitable retrieval) of a password that corresponds to user identification information received from a given user.

If the password received from that user does not sufficiently match the password retrieved from the table (or other data format), then the system 16 determines that the received user information and password do not appear to be valid. In that event, the system 16 may provide the user with a message or other indicia indicating the failure to receive proper user identification information and/or a proper user password, and may either return the user to the prompt to enter such information (box 50) or end the session (box 54).

On the other hand, if the password received from that user sufficiently matches the password retrieved from the table (or other data format), then the system determines that the received user information and password appear valid and allows the user to proceed with the session, as represented by the “Y” arm extending from box 52. In that event, the system 16 may provide the user with access to one or more selectable resources, such as items of information or services. For example, the user may be provided with a page, menu or other data format that provides a plurality of user-selectable identifiers, icons or other indicia representing information items and/or services available to that user from the system 16.

The system 16 may provide access to different optional resources or activities (including accessing different information items and services and/or subscription options) to different users and to different types or groups of users, such that each user may have a customized experience and/or each type or group of user (e.g., users who have paid subscription fees or the like) may have a different set of information items, services and/or subscription options available on the system. The system 16 may include or employ one or more suitable resource provisioning programs or systems for allocating appropriate resources to each user or type of user, based on a pre-defined authorization plan. Resource provisioning systems are well known in connection with provisioning of electronic office resources (e-mail, software programs under license, sensitive data, etc.) in an office environment, for example, in a local area network LAN for an office, company or firm. In one example embodiment, such resource provisioning systems is adapted to control access to information on the system 16, based on the type of user and/or the identity of the user.

Member-User Processes:

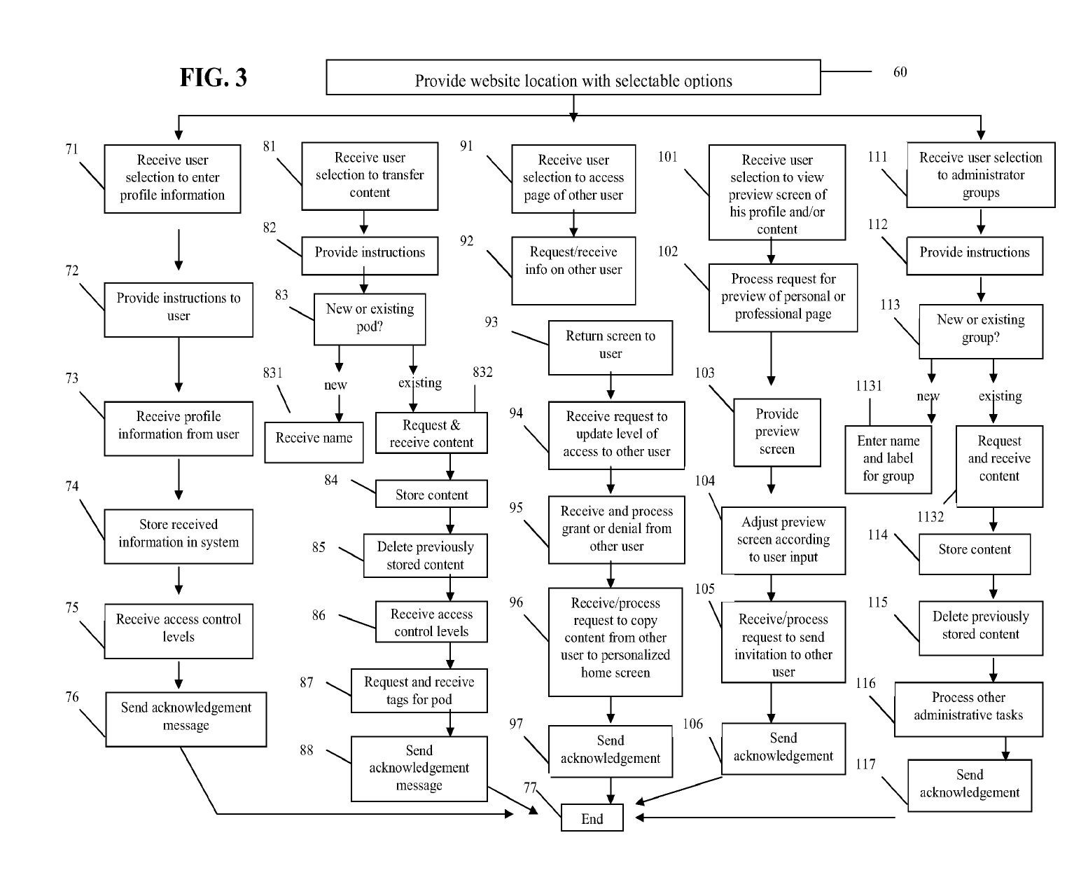

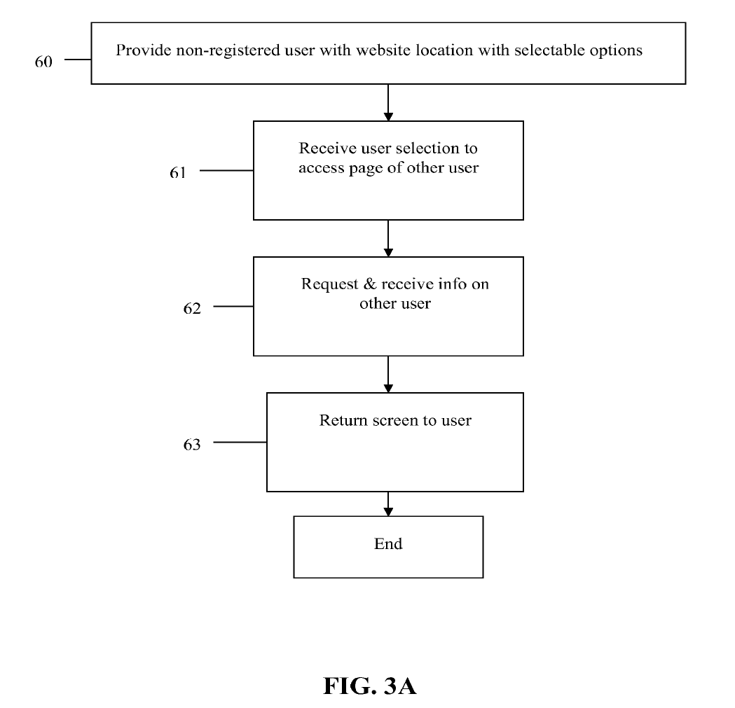

If the user is a member-user, then upon entering successful verification of the user's identification information and password, the member-user may be provided access to secure, personalized information stored on the system 16. For example, the member-user may be provided access to a secure, personalized website location assigned to the subject, as represented by box 60 in FIG. 3. The personalized website location may provide a personalized home screen to the member-user, including selectable icons or menu items for selecting optional activities, including, for example, an option to enter (or otherwise modify) profile information associated with the member-user, upload files from the member-user's computer 14 to the system 16 (and/or manage previously uploaded files), view previews of the member-user's information, as viewable by other users (registered and/or unregistered), and/or perform administrative tasks concerning groups owned and/or controlled by the member-user.

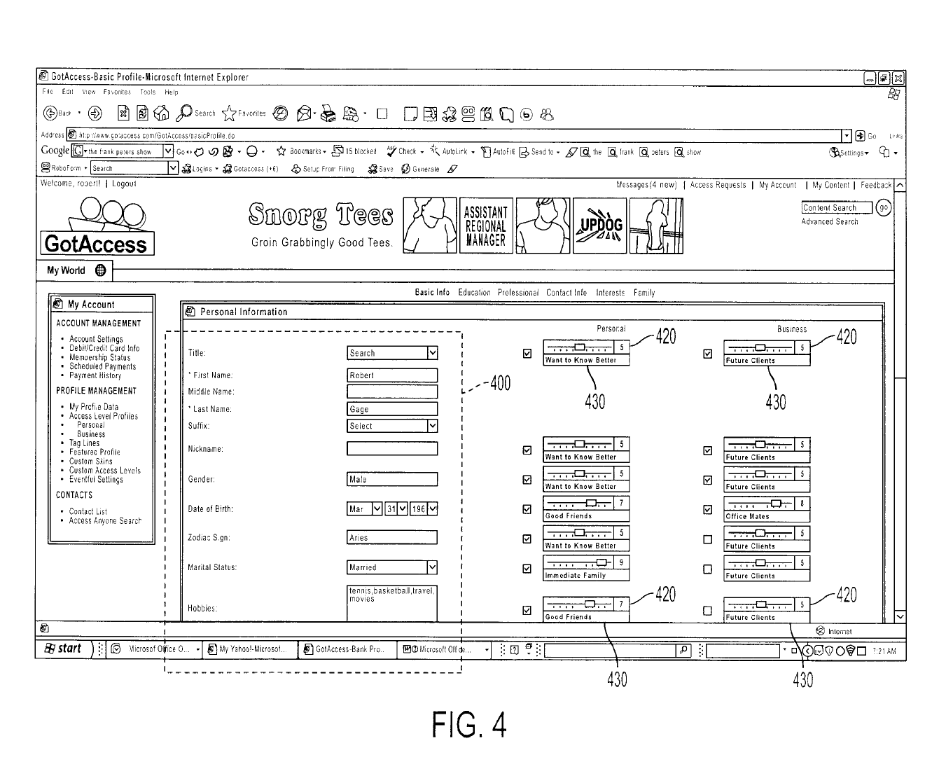

FIG. 3 is a flow-chart of example optional processes that may be performed with a member-user. In FIG. 3, upon providing the member-user with a plurality of user-selectable options for resources on the user's personalized website location (box 60), the user may select an option to enter (or otherwise modify) profile information associated with the member-user (box 71). The system 16 may receive manually entered information from the member-user in any suitable manner, as represented by box 73. For example, as represented by box 72, the system 16 may prompt the member-user with queries or other messages, indicating the type of information that the member-user may manually enter. In one embodiment, such queries (and prompts) may depend upon particular characteristics or attributes concerning the member-user, which the system 16 may determine during the member-user's registration process. For example, with reference to FIG. 4, to receive a user's manually entered information, the system 16 may present a template 400 to the computer 14, where the template has queries and/or defined locations for inputting specific information to the computer 14 for completion by the member-user and for submitting to the system 16, when completed. The defined locations of the template 400 may be for inputting information including, but not limited to, the member-user's nickname, gender, date of birth, zodiac sign, marital status, and/or hobbies. (Alternatively, such a form may have been previously stored on the computer 14, for example, as part of the loading of the system 10 software into the computer 14).

A member-user may manually enter information, for example, using standard (or non-standard) user interface devices on the computer 14, including, but not limited to, a keyboard, a keypad, a mouse, a touch screen, an optical input device, or the like. In further embodiments, other external devices (not shown) may be connected to the computer 14, for allowing a member-user to manually input information.

Such manually entered information may be stored with (or associated with) access control levels that are selected by the member-user. The system 16 may receive the access control levels from the member-user in any suitable manner, as represented by box 75. For example, with reference to FIG. 4, the system 16 may present the member-user with a graphical user interface(s) 420 (GUI) such as slidable control bars for setting the access control level. Other examples of suitable GUIs include rotary knobs, interfaces facilitating keyboard entry, selectable icons, etc. For ease of description, embodiments of the invention will be described as presenting slidable control bars. In one embodiment, the access control levels are integers ranging from 0 to 10, inclusive. In other embodiments, other suitable ranges include 0 to 20, 0 to 50, 0 to 100, etc. For ease of description, embodiments of the invention will be described as providing access control levels as integers ranging from 0 to 10.

One or more pieces of the entered information may be associated with one of the access control levels. Such levels may be set such that, for example, potentially fewer pieces of information may be accessed by users assigned a lower access level and, conversely, potentially more pieces of information may be accessed by users assigned a higher access level. Access to the member-user's information, as governed by the access control levels, will be described in more detail later.

In addition, one or more of the pieces of information may be associated with two (or more) access control levels. For example, in one embodiment, a single piece of information may be associated with both a first access control level (which, in a further embodiment, governs access to the member-user's personal page (or pages)) and a second access control level (which, in a further embodiment, governs access to the member-user's professional (or business) page (or pages)). As such, as will be described in more detail below, the member-user may create two pages (or sets of pages) that are at least partially different: a personal page (for viewing by his casual acquaintances, friends, and family members, for example); and a professional page (for viewing by his professional acquaintances, clients and prospective clients, co-workers, subordinates, and managers).

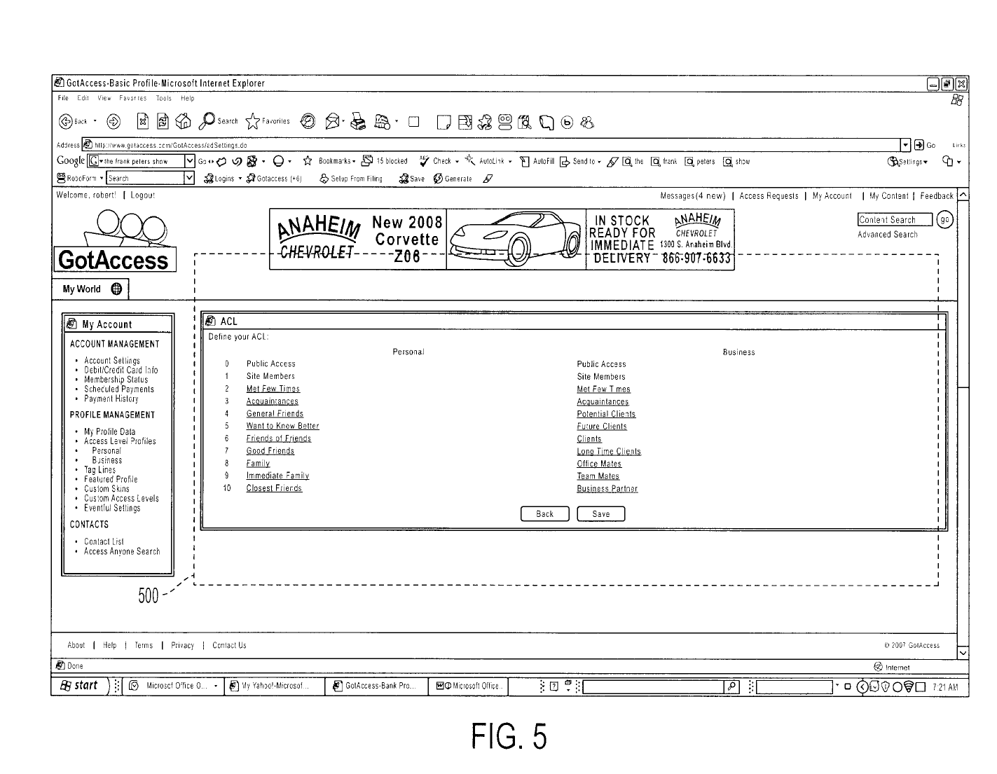

With reference to FIG. 4, the member-user may enter a label 430 for each or one or more of the access control levels. For example, as shown in FIG. 4, first access control levels (e.g., personal access control levels) of 5, 7 and 9 are respectively labeled as “Want to Know Better,” “Good Friends,” and “Immediate Family.” Similarly, as also shown in FIG. 4, second access control levels (e.g., professional access control levels) of 5 and 7 are respectively labeled as “Future Clients” and “Office Mates.” In one embodiment, the labels may be entered by the member-user as part of a template 500 provided by the system 16, as shown in FIG. 5.

With reference back to FIG. 3, as represented by box 76, the data management system 16 may provide an acknowledgment message back to the computer, for example, upon a successful receipt of the entered information (and/or the selected control levels) to a system 16 server and/or storage of the entered information (and/or the selected control levels) in a database (or database section) established for the member-user. The member-user may be prompted again to select an activity or resource available on the system 16, for example, by being returned to the member-user's personalized user website location (box 60). Alternatively, or in addition, if no further activities are to be performed with the system 16, the communication session may be ended, as represented by box 77.

If the system 16 receives a member-user's request to upload files from the member-user's computer 14 to the system 16 (and/or manage previously transferred files) (box 81), the system 16 may provide the user with step-by-step instructions on how to do so. For example, as represented by box 83, the system 16 may query the member-user whether the content to be managed relates to a new or previously created “pod.” According to one embodiment, a pod is defined as an electronic “container,” similar to a directory or folder in a computing system environment) for containing one or more pieces of content. If the pod is to be a newly created pod, the system requests that the member-user enter the name for the pod (box 831). Otherwise, if the content to be managed relates to a previously created pod, the member-user is requested to select the existing pod. Content corresponding to the newly/previously created pod may then be managed.

For example, as represented by box 832, the system 16 may request the member-user to transfer content from the computer 14 (or any peripheral device in communication with the computer 14) to the system 16. As represented by box 832 in FIG. 3, information retrieved from the computer 14 is communicated to and received by the data management system 16. Such information may be communicated through the Internet, for example, as part of the Internet communication session established between the computer 14 and the data management system 16.

The personalized home screen to the member-user may include an icon corresponding to the selected pod. The transferred content may be retrieved by selecting the icon corresponding to the selected pod. In addition, the system 16 may request that the member-user indicate whether he wishes to delete from the system 16 any content that was previously communicated to the system. As represented by box 85 in FIG. 3, the selected content is deleted from the system 16 in response to the member-user's request. In one embodiment, to provide additional security and/or privacy, the selected content is permanently deleted from the system 16 (e.g., by writing alternating 1's and 0's over the selected content), rather than merely hidden from view by the member-user (and/or any other users of the system). In other embodiments, the selected content may be deleted in other suitable ways, e.g., overwriting the content using other suitable patterns, overwriting the security key(s) to encrypted data corresponding to the selected content, purging the content, etc.

In conjunction with the storage and/or deletion of content, as represented by box 86, the system 16 may request the member-user to provide/update access control levels corresponding to the selected pod. The access control levels corresponding to the pods may be similar to the access control levels described previously with respect to the profile information. In more detail, the system 16 may receive the access control levels from the member-user in any suitable manner. For example, as was shown in FIG. 4, the system 16 may present the member-user with a GUI(s) 420 such as slidable control bars for setting the access control level. In one embodiment, the access control levels correspond to integers ranging from 0 to 10, inclusive. One or more pods may be associated with one of the access control levels. In addition, one or more pods may be associated with two (or more) access control levels. For example, in one embodiment, a pod may be associated with both a first access control level (which governs access to the member-user's personal page) and a second access control level (which governs access to the member-user's professional (or business) page).

The governing of the access to the above pages will be described in more detail later. As previously described with respect to the profile information, labels associated with one or more of the access control levels may be entered by the member-user. In one embodiment, the labels corresponding to the access levels for the profile information extend to the access levels for the pods. That is, the labels for the access levels for the profile information are identical to the labels for the access levels for the pods. In another embodiment, the labels corresponding to the access levels for the profile information are different (or at least partially different) from those corresponding to the access levels for the pods.

Further, in conjunction with the storage and/or deletion of content, as represented by box 87 of FIG. 3, the system 16 may request that the member-user provide/update tags corresponding to the selected pod. In one embodiment, the tags are text-based strings that may describe and/or characterize the content contained in the pod. For example, a pod containing photos of the California shoreline may be associated with tags such as “California,” “shoreline,” “scenery,” “beaches,” “nature,” and the like. In other embodiments, the tags may include textual characters and/or other visual symbols such as icons, photographs, thumbnails, drawings, and the like. As content is stored and/or deleted in the management of the pod, the tags associated with the pod may be updated accordingly by the member-user.

As represented by box 88, the data management system 16 may provide an acknowledgment message back to the computer, for example, upon a successful receipt of the entered information and/or the selected control levels to a system 16 server and/or storage of the entered information and/or the selected control levels in a database section established for the member-user. The member-user may be prompted again to select an activity or resource available on the system 16, for example, by being returned to the member-user's personalized user website location (box 60). Alternatively, or in addition, if no further activities are to be performed with the system 16, the communication session may be ended, as represented by box 77.

If the system 16 receives a member-user's request to access a page of another member-user (box 91), the system 16 may provide the user with step-by-step instructions on how to do so. For example, as represented by box 92, the system 16 may query the member-user to enter information regarding the other user-member. For example, the system 16 may ask the member-user to manually enter the user identification [as described earlier, with respect to the registration process] of the other user. In other embodiments, the member-user may search for other member-users based on information such as certain keywords (interests, hobbies, industries), the member-user's first name and/or surname, nickname(s), e-mail address, and/or other general identifying information. The system receives the entered user identification and returns a screen to the member-user (box 93).

The screen contains information and/or links to information that the member-user is allowed to access. The information is provided according to the access control levels assigned (or granted) to the member-user by the system 16 and/or the member-user who is to be accessed. In one embodiment, where personal and professional pages are created for each member-user, accessing member-users are assigned both a personal access control level of “1” and a professional access control level of “1” to pages created for all member-users (not including, of course, himself). However, as will be explained in more detail below, the accessing member-user may request that he be granted higher levels of access (e.g., levels higher than “1”) from one or more other member-users.

In one embodiment, users who are not registered in the system 16 (non-registered users) may also search and access pages created for member-users (see, for example, FIG. 3A). Such searches may be performed using a website location provided by the system 16 for non-registered users (box 60′). As is known in the art, such searches can be also performed using search engines, such as those operated by Google and Yahoo. Here, in one embodiment, such non-member users are assigned both a personal access control level of “0” and a professional access control level of “0” to pages created for all member-users (not including, of course, himself). As such, the pages of member-users will be accessible (at least to some degree) by users other than system registrants. However, because the default access control level for such individuals is 0, which is less than 1, the quantity of information that may be accessed is potentially less than the quantity that may be accessed by registered users. The system receives the entered user identification (or search information) and returns a screen to the non-registered user (box 63).

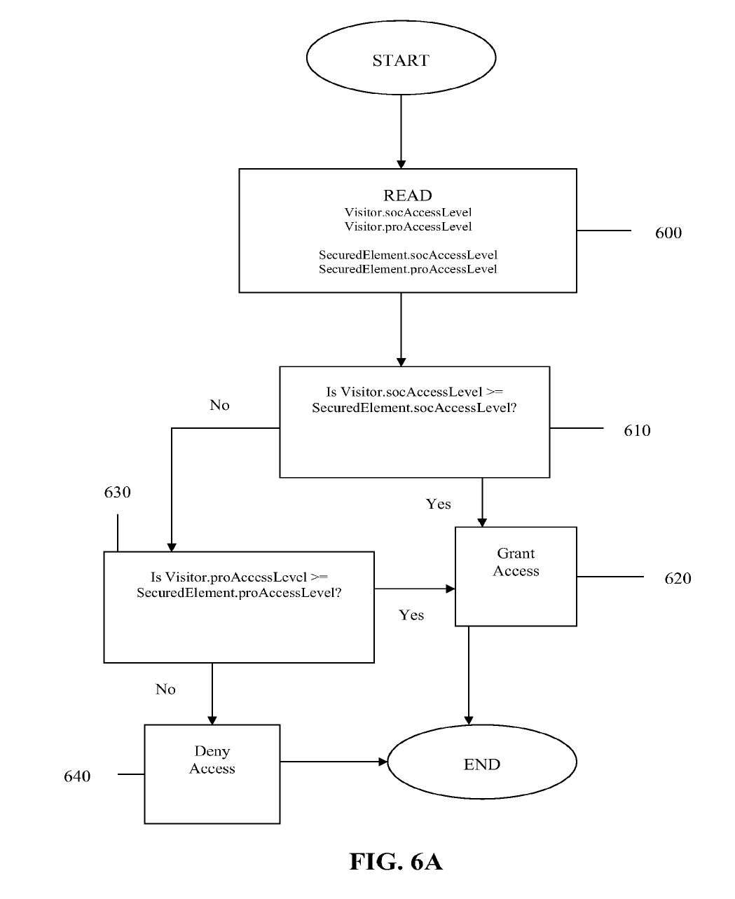

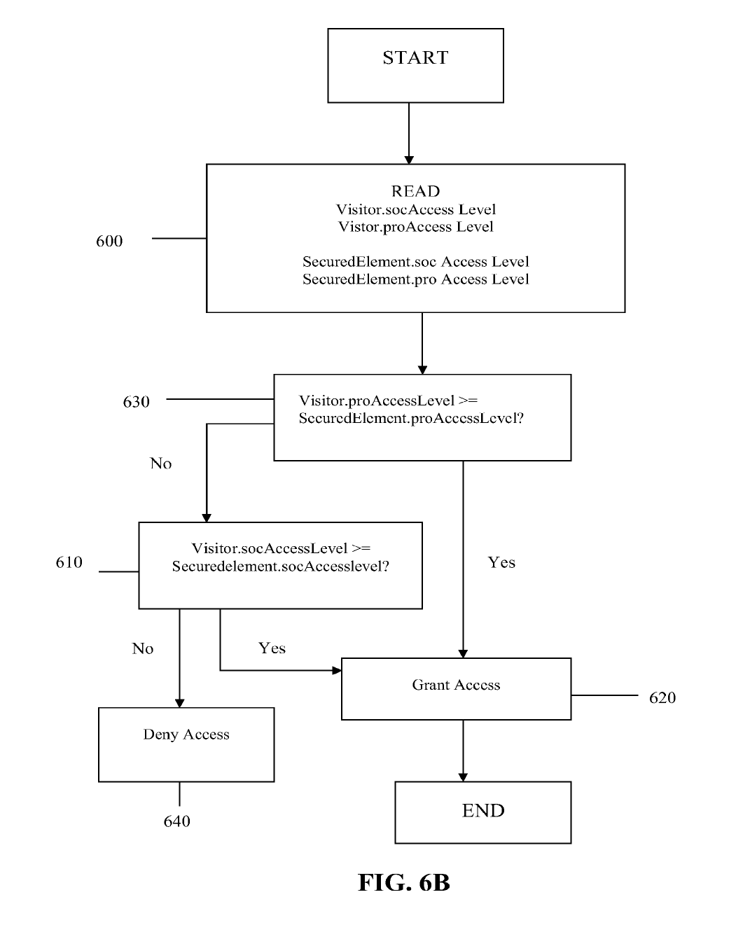

The governing, by the system, of access to content, using the access control levels, is shown in the flowchart of FIG. 6A. Here, an accessing user (registered or non-registered) wishes to access the content provided by a registered user. As shown in FIG. 6A, in box 600, the accessing member-user's personal access level and professional access level are read. In addition, the personal access level and professional access level of each piece of content (e.g., each piece of profile information and each pod). Next, the read values are compared to determine whether the accessing user is provided access to the content. For example, with reference to box 610, for each piece of profile information and/or each pod, the system determines whether the accessing user's personal access control level is greater than or equal to the personal access control level of the content (referred to herein as the personal access control level condition). If yes, then, with reference to box 620, access will be provided to the accessing user. If not, then, with reference to box 630, the system determines whether the accessing user's professional access control level is greater than or equal to the professional access control level of the content (referred to herein as the professional access control level condition). If yes, then, with reference to box 620, access will be provided to the accessing user. If not, then access will be denied (see box 640). If access is provided, then the particular piece of content will appear on the screen returned to the accessing user. Otherwise, the information will not appear on the screen returned to the member-user.

As such, the quantity of content that may be accessed by an accessing user who is not registered may be potentially less than the quantity of content that may be accessed by an accessing user who is registered. As previously explained, the default access control levels for non-registered users (“0”) are less than the default access control levels for registered users (“1”). Accordingly, non-registered users are able to access only those pieces of content that were assigned either a personal access control level of 0 or a professional access control level of 0. The non-registered user will be denied access to pieces of content that were assigned both a personal access control level of 1 or higher and a professional access control level of 1 or higher. In contrast, registered users are able to access pieces of content that were assigned either (a) a personal access control level of 0 or 1 or (b) a professional access control level of 0 or 1. The non-registered user will be denied access to pieces of content that were assigned both a personal access control level of 2 or higher and a professional access control level of 2 or higher.

One skilled in the art will appreciate that, in other embodiments, steps shown in FIG. 6A may be performed in a different order. For example, according to FIG. 6A, the personal access control levels are compared before the professional access control levels are compared. In an alternative embodiment, with reference to FIG. 6B, the professional access control levels are compared before the personal access control levels are compared. Further, while lower numbers are used in described embodiments to show lower levels of access, other embodiments may use higher numbers to show lower levels of access and lower numbers to show higher levels of access.

In a further embodiment, an accessing member-user may request that he be granted a level of access to the content provided by a certain member-user that is different from (e.g., higher than) the level of access that he currently has (see, e.g., box 94, of FIG. 3). Here, the accessing user may contact the member-user, for example, via a system 16-internal e-mail message, to present such a request. Via the system 16, the providing member-user may either grant or deny the request (box 95). In one embodiment, after the providing member-user has indicated that the request is granted, the system 16 assigns to the accessing user a personal access control level and/or a professional access level that is, for example, two levels higher than the current level(s). Here, the system 16 may present a GUI (such as a slidable bar, as shown, for example, in FIG. 4) that may be used by the providing member-user to select the desired access level. Once the system 16 receives the input from the providing member-user, the system updates the access level(s) of the accessing user accordingly (box 95).

According to a further embodiment, if the system 16 allows an accessing user-member to access certain content(s) from the page of another user-member, then the system 16 may query the accessing user-member whether he wishes to copy (or virtually copy) the contents to his own personalized home screen (box 96). For example, the system 16 may query an accessing user-member whether he wishes to copy a pod from the page of a co-worker to his own personalized home screen. Here, if the accessing user-member indicates such a desire, the system 16 provides a copy of the pod (or a link to the pod), which is represented as an additional icon on the accessing user's personalized home screen. As such, member users may exchange content amongst themselves more easily, and, after the exchanges have been made, individual users may access the content more conveniently.

As represented by box 97, the data management system 16 may provide an acknowledgment message back to the computer, for example, upon the completion of a search and/or an access level update The member-user may be prompted again to select an activity or resource available on the system 16, for example, by being returned to the member-user's personalized user website location (box 60). Alternatively, or in addition, if no further activities are to be performed with the system 16, the communication session may be ended, as represented by box 77.

If the system 16 receives a member-user's request to view previews of pages created for him by the system, as viewable by other users (registered and/or unregistered) (box 101), the system 16 may provide the user with step-by-step instructions on how to do so. As described with respect to one embodiment, the system creates two separate pages (e.g., a personal page and a professional page) using the personal and professional access control levels assigned by the member-user to the content that he has provided. As represented by box 102, the system 16 queries the member-user whether he wishes to view a preview of his personal page or his professional page. The system 16 receives the member-user's response and then provides the content according to a certain default personal/professional access control level (box 103).

For example, if the member-user indicates a desire to see a preview of his personal page, the system will display a preview screen showing the content that can be provided to all users having a personal access control level greater than or equal to the default personal access control level. Similarly, if the member-user indicates a desire to see a preview of his professional page, the system will display a preview screen showing the content that can be provided to all users having a professional access control level greater than or equal to the default professional access control level.

In one embodiment, if the member-user indicates a desire to see a preview of his personal page and the default personal access control level is 1, then the preview will show the content that can be provided to all users having a personal access control level of a certain (or pre-defined) range—e.g., 1 or 0. However, the preview will not show the content that can be provided only to users having a personal access control level data of another certain (or pre-defined) range—e.g., 2 or higher. It is understood that other embodiments may have different ranges for these levels of access.

Here, the system 16 may query the member-user whether he wishes to modify the access control level according to which the content is displayed for preview purposes (box 104). For example, in one embodiment, the system 16 may provide a slidable control bar by which the member-user may select an access control level different from the default level.

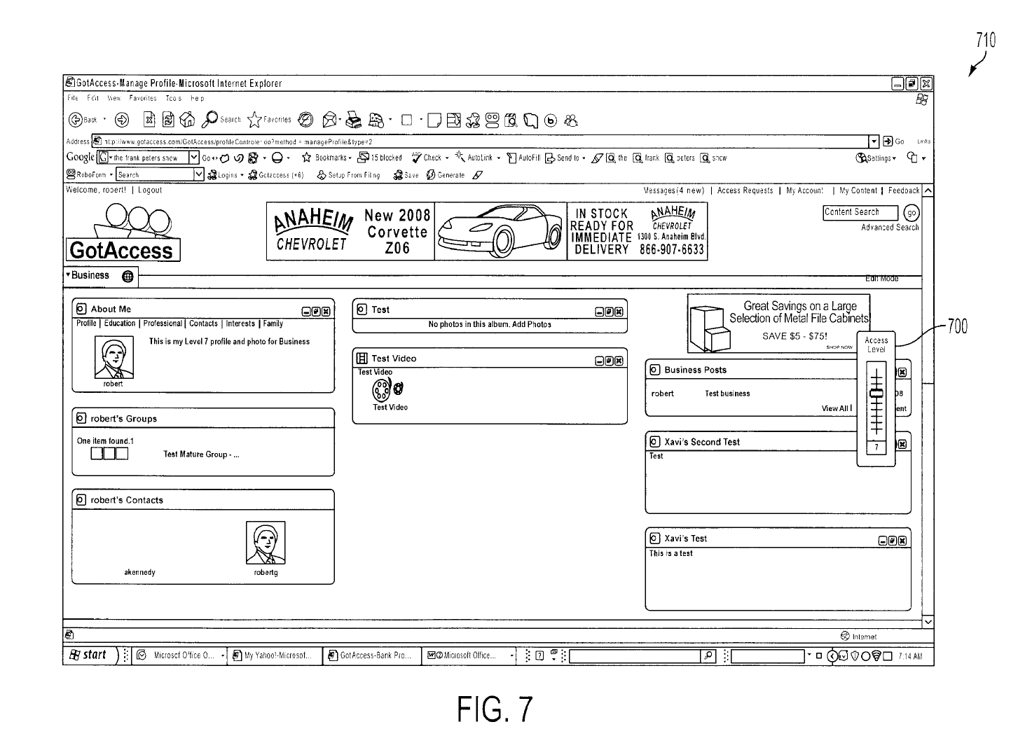

As shown in FIG. 7, the member-user has indicated using the slider 700 that he wishes to see a preview of the professional page that is available to users having a professional access control level of 7. The system 16 returns a screen 710 showing the preview to the member-user.

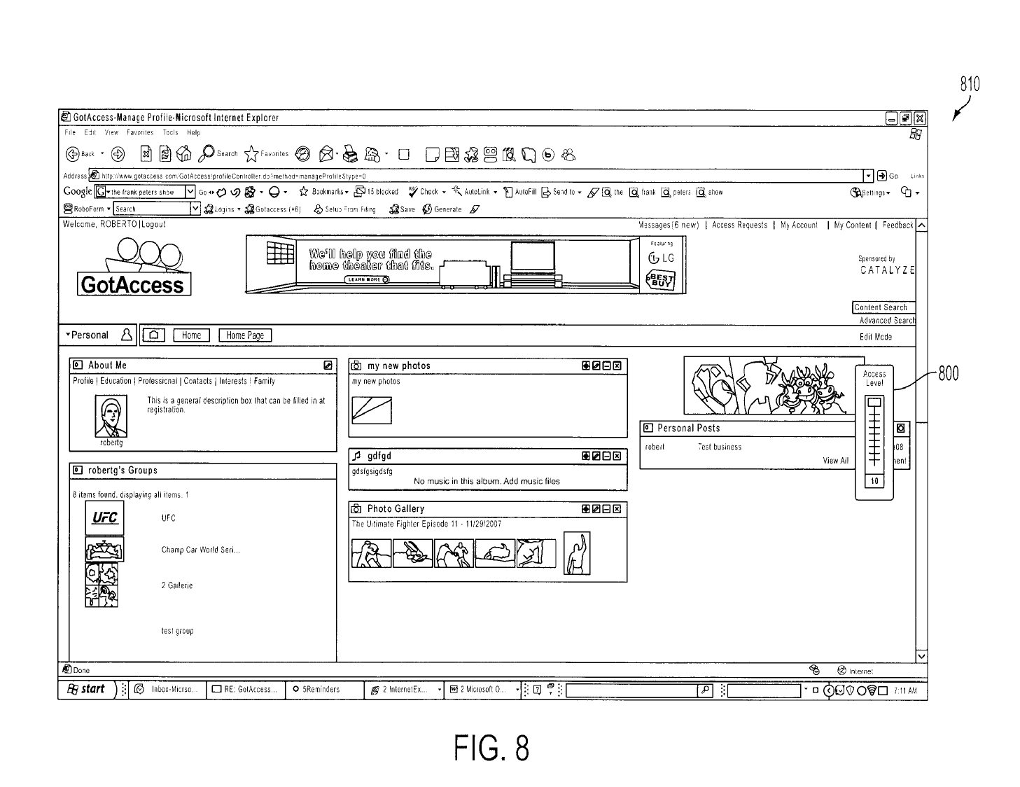

Similarly, as shown in FIG. 8, the member-user has indicated using the slider 800 that he wishes to see a preview of the personal page that is available to users having a personal access control level of 10. The system returns a screen 810 showing the preview to the member-user.

In a further embodiment, the member-user may send an invitation to another user to view his personal and/or professional page (box 105). Such an invitation may take the form of an e-mail message containing a link to the page. (Other examples of such invitations may take the form of a postal-delivered invitation, an instant message, a text message to a mobile device, a hand-delivered invitation (e.g., a business card), and the like.) In one embodiment, the link is in the form of a uniform resource locator (URL), as is known in the art. One skilled in the art will appreciate that such links are typically sent to those users who have the necessary access control levels to view the specific page. However, as an additional security and/or privacy measure, upon the entering of such a link, according to one embodiment, the system 16 verifies that the user of the link has a sufficiently high access control level(s) to view the content (see, for example, the governing of access to content, as shown in FIGS. 6A and 6B).

The above-described measure provides the member-user with protection from not only users registered in the system 16 but also non-registered users as well. For example, if the link sent by the member-user to a trusted member-user is posted on an Internet website that can be accessed by the general public, a member of the general public might attempt to view the link. However, such an attempt will be thwarted by the system 16 if the system 16 determines that the user attempting to view the corresponding page does not have a sufficiently high access control level to do so.

As represented by box 105, the data management system 16 may provide an acknowledgment message back to the computer, for example, upon a successful display of the preview(s) and/or transmission of an invitation to view the personal/professional page of the member-user. The member-user may be prompted again to select an activity or resource available on the system 16, for example, by being returned to the member-user's personalized user website location (box 60). Alternatively, or in addition, if no further activities are to be performed with the system 16, the communication session may be ended, as represented by box 77.

If the system 16 receives a member-user's request to perform administrative tasks concerning groups owned and/or controlled by the member-user (box 111), the system 16 may provide the user with step-by-step instructions on how to do so. In one embodiment, a group is similar to a pod, as described with respect to one embodiment. That is, a group corresponds to one or more “folders” containing content provided by the member-user. Here, multiple member-users may be designated as belonging to the group. Further, in one embodiment, the member-users may belong in different categories (e.g., subscription levels) within the group. Here, similar to the control of an user's access to content provided by a member-user, the system 16 may control a group member's access to the content according to the particular subscription level to which the group member belongs. Further, a group member's allowed level of participation in the administration of the group (if any) may also correspond to his particular subscription level.

As will be seen, administration of the groups is, in at least some respects, similar to administration of the profile information and the pods, as described above. For example, as represented by box 113, the system 16 may query the member-user whether the group to be managed relates to a new group or a previously created group. If the group is to be a newly created group, the system requests the member-user to enter a name for the group (box 1131). Further, the system may request the member-user to associate the group with one or more labels. The labels may describe the interests, goals, etc. associated with the group. These labels may be pre-defined or pre-determined. Also, the system may allow the member-user to define new labels for the group. Otherwise, if the group to be managed relates to a previously created group, the member-user is requested to select the existing group.

The administration corresponding to the newly/previously created pod may then be performed. For example, as represented by box 1132, the system 16 may request the member-user to enter content or transfer content from the computer 14 (or any peripheral device in communication with the computer 14) to the system 16. As represented by box 1132 in FIG. 3, information entered by the member-user and/or retrieved from the computer 14 is communicated to and received by the data management system 16. Such information may be communicated through the Internet, for example, as part of the Internet communication session established between the computer 14 and the data management system 16. The personalized home screen to the member-user may include an icon corresponding to the selected group. The entered and/or transferred content may be retrieved by selecting the icon corresponding to the selected group.

In addition, the system 16 may request the member-user to indicate whether he wishes to delete from the system 16 any content that was previously communicated to the system. As represented by box 115 in FIG. 3, the selected content is deleted from the system 16 in response to the member-user's request.

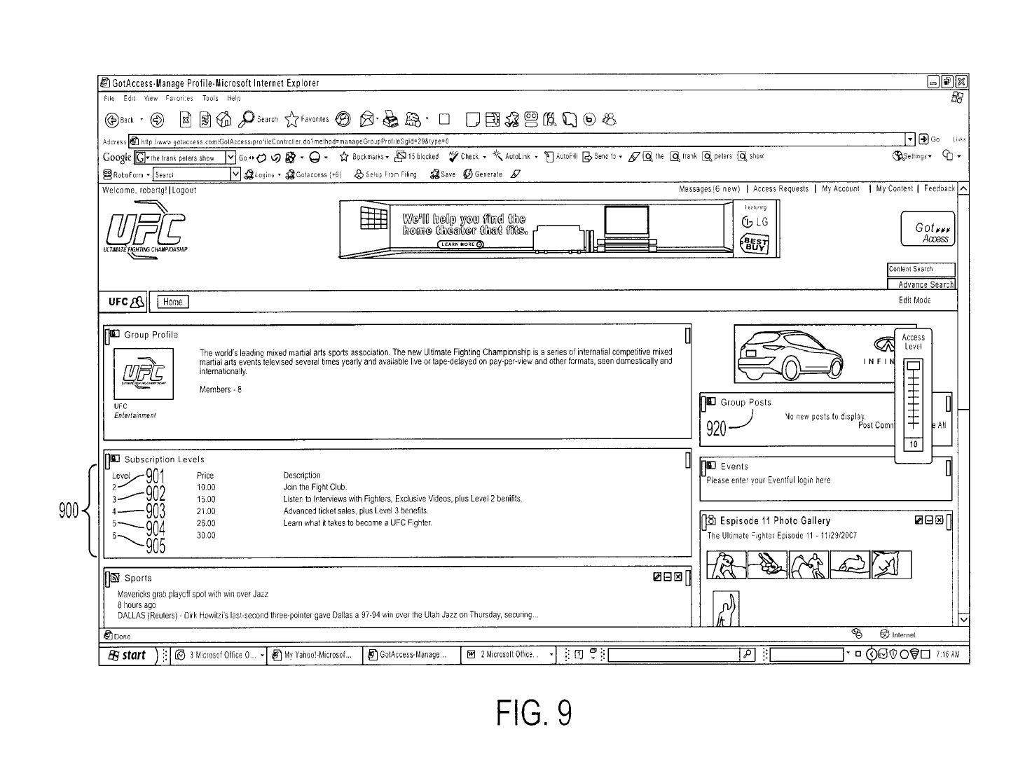

According to one embodiment, the system 16 may process other administrative tasks requested by the member-user (box 116). With reference to FIG. 9, a group has one or more categories 900 of member-users. As such, the group corresponds to one or more users, each of whom is categorized under one of one or more categories and is provided access to group-based content according to the category under which he is categorized. In one embodiment, the categories correspond to different subscription levels 901, 902, 903, 904, 905. That is, a member-user paying a subscription fee of $10.00, for example, may be provided access to content different from (or lesser in quantity and/or quality) than another member-user paying a subscription fee of $15.00. One skilled in the art will appreciate that such subscription fees can be any suitable amount and can be paid (or submitted) on a one-time basis or on a more periodic (or recurring) basis. In one embodiment, the management of the group roster, moderation of group discussions, and other similar administrative duties are performed by the group owner. As described with respect to certain embodiments, other group members (e.g., those who have subscribed to one of certain subscription levels) may assist the group owner in the management of the group roster, moderation of group discussions, and other such administrative duties.

As such, a group member is allowed to view group-based content and/or perform administrative duties commensurate with the level of his subscription. In a further embodiment, a group member is further allowed to provide (or post) group content commensurate with the level of his subscription. The system 16 facilitates the posting of content by a group member similar to the posting of content 920 by a group administrator, as shown with reference to FIG. 9.

As represented by box 117, the data management system 16 may provide an acknowledgment message back to the computer, for example, upon completion of the formation and/or administration of the group by the member-user. The member-user may be prompted again to select an activity or resource available on the system 16, for example, by being returned to the member-user's personalized user website location (box 60). Alternatively, or in addition, if no further activities are to be performed with the system 16, the communication session may be ended, as represented by box 77.

System-Generated Recommendations Between Members and/or Groups and Members

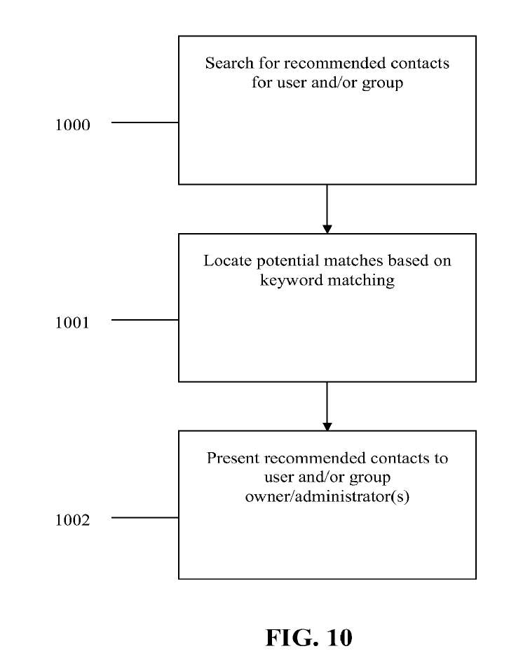

In one embodiment, with reference to FIG. 10, for each member-user, the system 16 may search for contacts (e.g., other member-users and/or certain groups) that would likely be of interest to the member-user (box 1000). Such recommended contacts may be displayed on the member-user's personalized home screen upon log in of the member-user to the system 16. As such, the social network of the member-user could be broadened.

Similarly, according to another embodiment, for each group, the system 16 may search for contacts (e.g., other member-users) who would likely be of interest to the group owner and/or group administrator(s) (box 1000). Such recommended contacts may be displayed on the owner's personalized home screen (and/or administrator's personalized home screen) upon log in to the system 16. As such, the membership of the group could be enlarged and widened.

In one embodiment, the searches performed by the system to produce the recommendations may be based on matches (or at least partial matches) between certain keywords located by the system 16 (box 1001). Such keywords may be located in the content provided by member-users (e.g., profile information entries, tags corresponding to pods created by member-users, and the like) and content provided by group owners and/or administrators (e.g., labels associated with the groups, certain words that are repeated at a sufficiently high frequency in group discussions and/or posts, etc).

For example, the system may recommend that a member-user consider joining certain groups and/or contact other member-users based on certain tags that he has associated with one or more of his pods (box 1002). Similarly, the system may recommend that a group owner(s) and/or administrator(s) consider inviting certain member-users to join the group based on a determined match (or matches) between the apparent interests of the group and those of the identified member-users (box 1002).

In one embodiment, the system will display the recommended contacts along with a relevance indicator (for example, in units of percentage). Here, those skilled in the art will appreciate that any one or more of known algorithms for determining the correlation between the recommended contacts and the recipient of the recommendation may be used.

It is contemplated that some registered users of the system 16 may not wish to be contacted by other members-users and/or groups in the manner described above with respect to certain embodiments. In one embodiment, as part of the registration process described previously (or anytime after a member has already registered), the system 16 may allow the member-user to request “block outs” of any such recommendations and/or invitations. That is, the system 16 refrains from making (or preempts) any such recommendations to the member-user, and, similarly, the system 16 refrains from recommending the member-user to groups. In a further embodiment, the member-user may be required by the system 16 to subscribe to a certain user-membership level (similar to the levels 900 of FIG. 9) before the above-described “block outs” are placed into effect. As with the subscription fees described with respect to the user groups (see, for example, the levels 900 of FIG. 9), the user-membership subscription fees can be paid (or submitted) on a one-time basis or on a more periodic (or recurring) basis.

Similarly, in one embodiment, group owners and/or administrators may pay (or submit) group registration fees (similar to the user-membership fees described above) so that the system refrains from recommending the group to additional member-users and the group is not contacted by other member-users in the manner described with respect to certain embodiments.

Member-Users as Gatekeepers to Other Member-Users

As described with respect to certain embodiments, the system 16 facilitates the searching of certain member-users by other member-users. As also described with respect to certain embodiments, member-users may assign personal and/or professional access control levels (e.g., between 0 to 10) to other member-users). Further, as also described with respect to certain embodiments, certain member-users may wish to limit the level of direct contact by other member-users. For example, a certain member-user may wish to receive direct contact from only those member-users who have been granted a certain level of access control (e.g., a level of 5 of higher) by the member-user himself. As described with respect to certain embodiments below, the “gatekeeping” feature, as provided by the system 16, places into effect the above-described limits on direct contact.

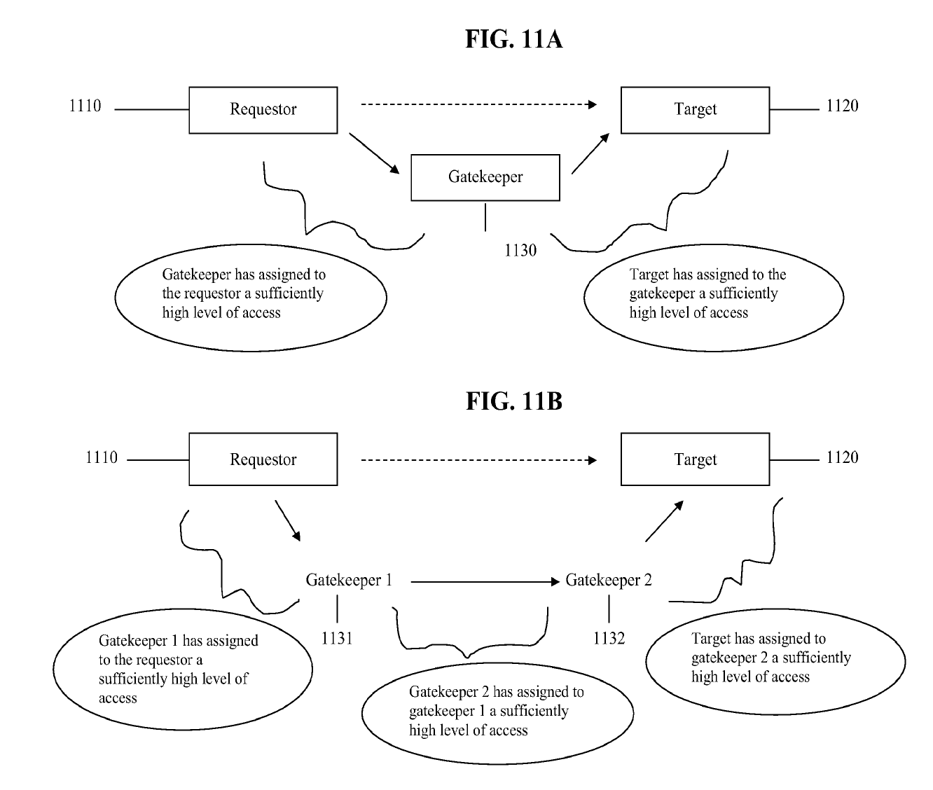

For example, with reference to FIG. 11A, according to one embodiment, when a first member-user 1110 (“requestor”) initiates a search by the system 16 and the system locates a second member-user 1120 (“target”) as a result of the search, the system 16 will reveal the identifying information pertaining to the target 1120 only if the requestor 1110 is already part of the target's trusted network (e.g., consisting of members who have been assigned an access control level of 5 or higher by the target). However, if the system determines that the requestor 1110 is not within the target's trusted network, the system will not reveal to the requestor 1110 such identifying information.

Rather, the system will reveal to the requestor 1110 that a target has been located and the basis (as determined by the system 16) for the location of the target (e.g., certain characteristics of the target which matched the search terms that were provided by the requestor). Further, the system 16 engine will reveal the characteristics by which the target matches the search terms. Furthermore, the system will reveal potential indirect connections to the target through other member-users 1130 who are part of the target's trusted network. Gatekeepers 1130 are defined as such member-users, through which indirect connections to the target may be formed. In a situation where multiple gatekeepers are located by the system and a connection from the member-user to the target may be formed through any one of the multiple gatekeepers 1130, the system may choose the gatekeeper 1130 through which a connection between the requestor 1110 and the target 1120 will most likely be formed. In one embodiment, the gatekeeper is chosen by the system 16 to maximize the strength of the association between the member-user and the gatekeeper (e.g., the access control level that has been assigned by the gatekeeper to the member-user) and/or the strength of the association between the gatekeeper and the target (e.g., the access control level that has been assigned by the target to the gatekeeper).

According to one embodiment, once the system 16 has located a target for a member-user and identified a gatekeeper through which the member-user may access the target, the system allows the member-user to request that the gatekeeper introduce the member-user to the target.

When the gatekeeper receives such a request, the gatekeeper may or may not decide to introduce the member-user to the target. If the gatekeeper does make the introduction, the target may decide either to accept or reject the introduction (i.e., grant or deny access to the member-user) based on the gatekeeper's introduction of the member-user and/or information on the member-user, as viewable via the system 16.

In further embodiments, with reference to FIG. 11B, the system may locate two or more gatekeepers 1130, through which the requestor 1110 may be introduced to the target 1120 in successive order. As such, introductions are performed via successive links (e.g., between the requestor 1110 and a first gatekeeper 1131, between the first gatekeeper 1131 and a second gatekeeper 1132, and between the second gatekeeper 1132 and the target 1120). The introduction in any one of these links may be performed in the manner described earlier, with reference to FIG. 11A.

In one embodiment, the target may follow any one of three options in replying to the introduction by the gatekeeper: Access Granted; Access Denied; and Access Banned.

If access to the target is granted, the member-user is allowed to contact the target directly. Here, the gatekeeper and the target may decide how/when such contact should take place.

If access is denied, the target has indicated that he is unwilling to be contacted directly by the member-user, at least at the present. The system will inform the gatekeeper of the target's decision, and the gatekeeper will then have the opportunity to inform the member-user of the target's decision. The system 16 may also provide the gatekeeper with training materials on creating more successful social connections between parties that are known to him (but unknown to each other). However, the user-member is not prevented from making future attempts to indirectly contact the target (i.e., through a gatekeeper).

If access is banned, the target has indicated that he is unwilling to be contacted directly by the member-user on a permanent basis, and the user-member will be prevented from making any attempts to contact the target through a gatekeeper. Here, the system will inform the gatekeeper of the target's decision, and the gatekeeper will then have the opportunity to inform the member-user of the target's decision. The system 16 may also provide the gatekeeper with training materials on creating more successful social connections between parties known to him (but unknown to each other).

Through the use of gatekeepers in the system 16, as described above, the system is able to facilitate attempts to forge relationships between two parties through the use of a third-party intermediary (the gatekeeper). As described above with respect to certain embodiments, the system 16 may increase the likelihood of success by choosing the strongest relationships (or links) between the gatekeeper and each of the two parties, using the access control levels that are maintained in the system 16.

While embodiments of the present invention described above involve connection to the data management system 16, through the Internet, other embodiments may employ other suitable wide area networks. In yet other embodiments involving more limited distribution groups, local area networks may be employed.

The foregoing description of the preferred embodiment of the invention has been presented for the purposes of illustration and description. It is not intended to be exhaustive or to limit the invention to the precise form disclosed. Many modifications and variations are possible in light of the above teachings. Therefore, it is intended that the scope of the invention be limited not by this detailed description, but rather by the claims appended hereto.

1.-20. (canceled)

21. A system for controlling access to data on an electronic communication network, the system comprising at least one server having a computer-readable storage device, the at least one server connectable for communication on the network, the at least one server configured for:
receiving data, via the network, from a user of a plurality of users;
storing the data on the storage device;
generating control levels for allowing access to the data, the control levels comprising a first set of control levels and a second set of control levels, the first set of control levels corresponding to a first portion of the data, each of the control levels of the first set corresponding to an amount of access to the first portion of the data, the second set of control levels corresponding to a second portion of the data, each of the control levels of the second set corresponding to an amount of access to the second portion of the data;
receiving a first request, via the network, from the user for a preview of a first page that allows access to at least some of the first portion of the data;
providing the preview of the first page, via the network, to the user in response to receiving the first request;
receiving a selected control level from among the first set of control levels, via the network, from the user; and
providing an updated preview of the first page, via the network, to the user based on the selected control level of the first set of control levels.

22. The system according to claim 21, the at least one server further configured for:
providing the first page to a second user of the plurality of users having an access level meeting or exceeding the selected control level.

23. The system according to claim 21, wherein the preview of the first page corresponds to a view of the first page.

24. The system according to claim 21, wherein the updated preview of the first page corresponds to a view of the first page displayed to other users of the plurality of users having access levels meeting or exceeding the selected control level.

25. The system according to claim 21, the at least one server configured for:
providing a graphical user interface to the user, the graphical user interface configured to received the selected control level from the user;
wherein the graphical user interface comprises a slidable control bar for selecting the selected control level from among the first set of control levels.

26. The system according to claim 21, the at least one server configured for:
receiving a second request, via the network, from the user for a preview of a second page that allows access to at least some of the second portion of the data;
providing the preview of the second page, via the network, to the user in response to receiving the second request;
receiving a selected control level from among the second set of control levels, via the network, from the user; and
providing an updated preview of the second page, via the network, to the user based on the selected control level of the second set of control levels.

27. The system according to claim 26, the at least one server further configured for:
providing the second page to a second user of the plurality of users having an access level meeting or exceeding the selected control level.

28. The system according to claim 26, wherein the updated preview of the second page corresponds to a view of the second page displayed to other users of the plurality of users having access levels meeting or exceeding the selected control level.

29. The system according to claim 26, the at least one server configured for:
providing a graphical user interface to the user, the graphical user interface configured to receive one or more of the selected control levels of the first set of control levels and the second set of control levels;
wherein the graphical user interface comprises a first slidable control bar for selecting the selected control level from among the first set of control levels and a second slidable control bar for selecting the selected control level from among the second set of control levels.

30. The system according to claim 21, the at least one server configured for:
transmitting an invitation to a second user of the plurality of users having an access level meeting or exceeding the selected level to view the first page.

31. The system according to claim 30, wherein the invitation includes a link to the first page.

32. The system according to claim 30, wherein the invitation comprises one or more of an email message, a post-delivered message, an instant message, a text message, and a hand-delivered message.

33. The system according to claim 21, wherein the first portion of the data is at least partially different from the second portion of the data.

34. The system according to claim 21, wherein the first set of control levels has a same number of control levels as the second set of control levels.

35. The system according to claim 21, wherein at least some of the first portion of the data is the same as at least some of the second portion of the data.

36. The system according to claim 21, wherein the first set of control levels is at least partially different from the second set of control levels.

37. A method for controlling access to data on an electronic communication network, the method comprising:
connecting at least one server to the network, the at least one server having a computer-readable storage device;
configuring the at least one server for:
receiving data, via the network, from a user of a plurality of users;
storing the data on the storage device;
generating control levels for allowing access to the data, the control levels comprising a first set of control levels and a second set of control levels, the first set of levels corresponding to a first portion of the data, each of the control levels corresponding to a first portion of the data, each of the control levels of the first set of corresponding to an amount of access to the first portion of the data, the second set of control level corresponding to a second portion of the data, each of the control levels of the second set corresponding to an amount of access to the second portion of the data;
receiving a first request, via the network, from the user for a preview of a first page that allows access to at least some of the first portion of the data;
providing the preview of the first page, via the network, to the user in response to receiving the first request;
receiving a selected control level from among the first set of control levels, via the network, from the user; and
providing an updated preview of the first page, via the network, to the user based on the selected control level of the first set of control levels.
